(19) United States
(12) Patent Application Publication
(10) Pub. No.: US 2006/0059023 A1
(43) Pub. Date: Mar. 16, 2006

(54) Method system and apparatus for providing transportation services

(76) Inventor: Alex Mashinsky, Memphis, TN (US)

Correspondence Address: Alex Mashinsky, 510 Berkeley, Memphis, TN, 38120, US

(21) Appl. No.: 10/523,501

(22) PCT Filed: Aug. 4, 2003
(86) PCT No.: PCT/US03/24252

§ 371 Date: Sep. 2, 2005

Related U.S. Application Data
(60) Provisional application No. 60/400,603, filed on Aug. 2, 2002.

(51) Int. Cl. G06Q 10/00

(52) U.S. Cl. 705/5

(57) ABSTRACT

A system and method for providing taxi patrons with a taxi-reservation system which facilitates better taxi service, better time utilization and financial rewards for taxi drivers who provide better service, and more efficient pricing for buyers. The taxi-reservation system allows patrons to rate the taxi service they receive as well as pre-select taxi drivers from a pool of available taxi drivers. The system further enables taxi drivers to participate in a pricing scheme where customers can bid on proposed fares for their trips, and drivers, dispatchers or companies can bid on customers.

### RELATED APPLICATIONS

This application claims priority to U.S. Provisional Patent Application No. 60/400,603 filed Aug. 2, 2002, which is herein incorporated by reference.

### FIELD

The present invention is directed to providing transportation services to potential customers, and more particularly to a method, system and apparatus for assisting customers with a real-time taxi reservation system that enables a pricing scheme for buyers, while rewarding better taxi drivers.

### BACKGROUND

While taxis are generally available for short-term availability to customers, there are thousands of private cars and limousines that are able to respond only to long term customer scheduling. In other words, it is difficult for these private cars to pick-up potential customers without going through a protracted reservation process. These cars work through a central telephone-based or Internet-based service that receives requests from customers for scheduled transportation. These services then communicate with drivers by cellular phone, beeper or other mobile communication device. A customer often needs to provide several hours of advance notice in order to be certain that they will be able to obtain car service.

Similar to other service-industry businesses, the car service business has remained unchanged for a long period of time. For example, the current arrangements give little pricing information to customers.

New York itself has over 30,000 car service drivers in addition to 11,000 regular cabs. The main problem facing customers is the unpredictable level of service and pricing provided by the different companies and different drivers. As a result, current systems are highly inefficient.

Furthermore, at present, drivers must suffer lengthy, unpaid waits and down time. Passengers have trouble getting cars on short notice. Further, there is no really effective way, short of always using the same driver, of predicting the general quality of the limousine service, in terms of timeliness, quality of car, driver friendliness, and the like. These problems and others are made even worse by the fact that supply and demand for these services is not static, during 7-10 am there is more demand than supply while during 10 am-4 pm there is more supply than demand. Then again from 4-8 PM the demand rises sharply only to disappear few hours later. The current pricing system does not allow for any flexibility for such drastic supply and demand characteristics to affect the actual prices paid by users for the service.

The inefficiencies in the taxi service industry stem primarily from a few reasons. There is currently no effective mechanism to ensure repeat business because taxi patrons generally have little say in the selection of a specific service provider (i.e. taxi driver). As such, there is little incentive for taxi drivers to provide better service. Also, the absence of a mechanism for repeat business prevents the evolution of a business relationship, where the service provider would learn how to efficiently satisfy a customer (such as by playing specific radio stations, talking certain routes, etc.). In addition, the supply and demand for taxi services vary greatly by time of day, location/route, weather, and the lice. Furthermore, most rides are one-way and have very high periods of wasted time due to the lack of centralized coordination between the need for cars and the available cars.

Furthermore, at present there is no access to information that can provide real-time traffic and routing data to drivers to help anticipate travel time or to redirect cars in case there is congestion or delays due to construction or events.

Furthermore there is no system of collecting satisfaction and rating information about individual cars, drivers and companies which can be accessible to riders ahead of their selection and reservation so they could make an informed decision. In addition none of these services are available online as part of the airline or hotel reservation systems.

As a result, there is a need for a car or taxi reservation system that helps address the above-mentioned disadvantages in existing systems.

### SUMMARY

In view of the above-mentioned disadvantages in the existing system, the present invention provides taxi patrons with a taxi-reservation system which allows better taxi service, better time utilization and financial rewards for taxi drivers who provide better service, and more efficient pricing for buyers. The taxi-reservation system allows patrons to rate the taxi service they receive as well as pre-select taxi drivers from a pool of available taxi drivers. In addition, the system further enables taxi drivers to participate in a pricing scheme where customers can bid on proposed fares for their trips, or alternatively, taxi drivers can bid on customers.

According to one embodiment, the present invention solves various problems associated with the identification, reservation, procurement, dispatch, navigation, location, meeting, pricing, rating and payment for car services by customers.

In one embodiment of the present invention, the invention involves a unique method operated by a user involving the following sequence: accessing a transportation reservation system via an Internet-enabled device, the transportation reservation system being in communication with a plurality of independent travel service providers; transmitting a travel service request to the transportation reservation system; receiving transportation service information from the transportation reservation system in response to the travel service request; transmitting a travel request confirmation to the transportation reservation system; and receiving transportation service in accordance with the confirmation.

In another embodiment of the invention, the invention involves a method of providing transportation services by a reservation service provider, including: receiving notification from a plurality of independent taxi drivers regarding availability for providing transportation; receiving a reservation request from a taxi customer; transmitting the reservation request to a first taxi driver; receiving confirmation from the first taxi driver regarding providing taxi services to the taxi customer in conformance with the reservation request; and transmitting the confirmation from the first taxi driver to the taxi customer.

These and other embodiments of the present invention will become more readily apparent upon a review of the following detailed description and accompanying claims.

### BRIEF DESCRIPTION OF THE DRAWINGS

Further aspects of the instant invention will be more readily appreciated upon a review of the detailed description of the preferred embodiments included below when taken in conjunction with the accompanying drawings, of which:

FIG. 1 is a block diagram depicting an exemplary network of a plurality of taxi customers, taxi drivers and a central controller according to the present invention;

FIG. 2 is a diagram illustrating an exemplary controller database accessible through the central controller of FIG. 1; and

FIG. 3 is a flowchart depicting an exemplary process over the network of FIG. 1.

### DETAILED DESCRIPTION OF THE INVENTION

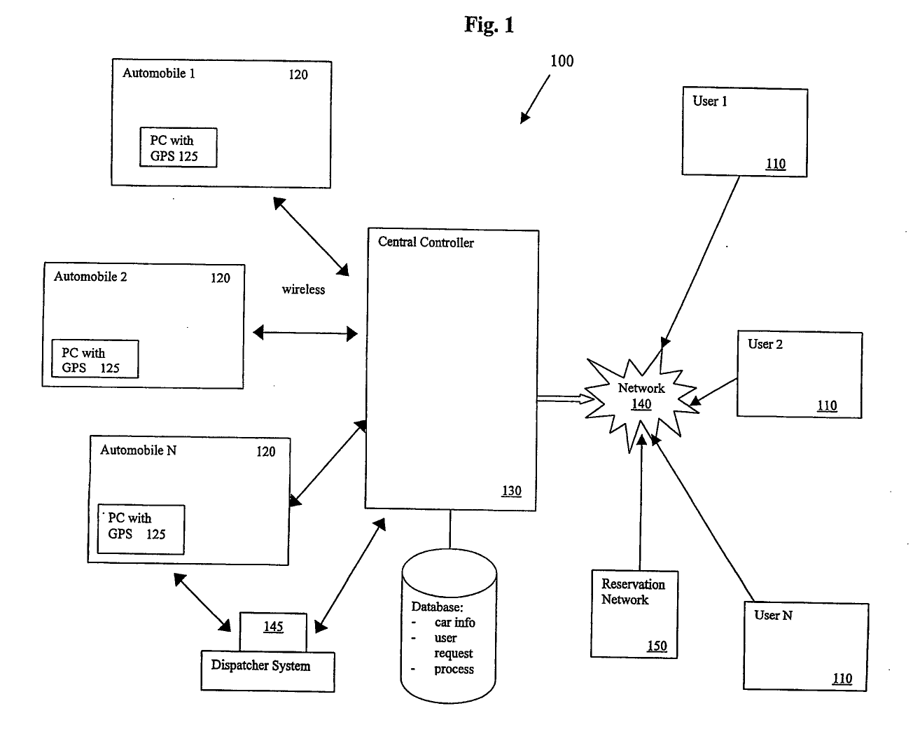

Referring now to FIGS. 1-3, wherein similar components of the present invention are referenced in like manner, various embodiments of a method, system and apparatus for providing transportation services to potential customers are disclosed.

The disclosed invention utilizes vehicles which are continually in transit, as a result of which their availability changes regularly. In addition, traffic conditions are never static, which creates a unique environment to allow the matching of supply and demand. The present invention creates a network that provides real-time traffic reports as well as the ability to track the average speed of taxis on particular routes and trip duration information using data available from wireless and Global Positioning System (GPS) networks. The data is then mapped to the actual route plans/maps to calculate the speed of transit and predict car arrival times.

According to the invention, any taxi customer, having a valid account, can hire a cab/taxi by providing a valid identification number. In one embodiment, the appropriate payment will be deducted from the customer's account and posted to the account of the specific driver of the cab providing the taxi ride. In other embodiments, payment can be provided directly to the driver. The system collects the traffic information trends and extracts the financial data to predict trends as well as performance and success of sales campaigns. For example, a decrease in occupancy rate for taxis, combined with lower ratings from customers, may result in poor financial performance and lower travel/taxi rates. Real-time access to such data gives drivers and companies a head start and allows them better planning of their resources and fares.

The taxi-reservation system provides taxi patrons and taxi drivers access to a system which allows patrons to rate the service they receive, pre-select taxi drivers from a pool of those available, and allows drivers and passengers to participate in reverse auction pricing. As a result, patrons enjoy better service and drivers receive financial rewards for providing that better service. Overall, the entire system is a more efficient scheme for matching supply and demand for taxi and car service.

The taxi-reservation system comprises an application with two user interfaces: a driver interface and a customer interface. The driver interface is accessible by registered taxi drivers and dispatchers who are equipped with a taxi-reservation system wireless devices (which includes GPS and wireless location capabilities) and necessary software. The software allows management of car inventory and availability, allows taxi drivers and dispatchers to bid for queued passengers and receive requests for quotes. Such software can operate on wireless devices, as well as computers connected to the internet or by using phones to call into an Interactive Voice Response (IVR) reservation system. It may also interface to reservation software operated by taxi rental and limo companies so all such functions can be performed automatically based on real time matching and rules designed to optimize the service and fleet utilization. The customer interface is accessible by any registered user or wholesale reservation network equipped with the interface protocol which is accessible via computer phone or any wireless access device (such as a Palm VII, Blackberry, WAP phone, and the like), which allows them to schedule, view and bid for available cars, cabs, and to rate driver service. The application server may reside anywhere on the Internet, and comprises commercial Relational Database Management Systems (RDBMS), middleware and presentation software with custom programming.

The taxi reservation system provider may receive subscription fees from customers, transaction fees from customers, subscription fees from drivers, transaction fees from drivers, and/or platform licensing fees from other interested businesses.

Turning now to FIG. 1, there is depicted a taxi-reservation system 100 comprising an exemplary network of a plurality of taxi customers 110, taxi drivers 120 and a central controller 130. The taxi drivers 120 are provided with a computer 125 having a GPS monitor and wireless communications in their automobiles. Data is collected remotely regarding each car by the central controller 130. Such data can be dispatched and collected via some existing or intermediate software and communication systems as described via computer 145. This data is made accessible to remote users by a smart and user-friendly manner via any Internet-network, wireless phone and/or the like 140.

This system allows both consumers 110 and drivers 120 or car service companies to locate the right company, car, driver, price, availability and then access historical information collected from other users as to the satisfaction level, thereby facilitating a real time decision. Such ranking and matching of drivers and passengers can be made based on many parameters including price, location, length of time required, pickup and delivery flexibility, willingness to share a ride, payment method, amount of gratitude, ranking, car type and other parameters

Matching is done based on three processes, riders 110 request data is placed in 130 and is submitted to local systems 145 and 125 for matching and biding, all availability data is submitted by 125 and 145 to 130 which then makes immediate decision each time a request comes in from a user 110 or system 130 lists all offers from both sides and allows matching to be done by the users. The GPS-enabled devices 125 in the taxi cabs can automate the process of selection, and extend the tracing of vehicles or drivers by incorporating GPS and cellular tracing technologies which allow for automatic rescheduling and notification of both customers 110 and drivers 120. In addition, these devices 125 pin-point location information which can be forwarded to customers 110 via wireless devices as to the exact location for the meeting point and the contact information for the specific driver 120 can be matched. In addition, this system 100 allows the notification of drivers 120 of changes in flight, train, and ship arrival and departure information where necessary so that rescheduling can be made immediately upon such information becoming available, as opposed to the common practice of having car drivers sit and wait just to be notified of the delays or cancellation.

The taxi-reservation system 100 provides origin and destination data which is submitted by the user 110. This information is then used by the car companies either in real time or ahead of a reservation. This arrangement allows the drivers 120 with the higher customer ratings to charge more than other drivers or allow drivers with vans or luxury cars to charge more than drivers with older sedans. The system 100 also automatically provides pricing information based on time of day so supply & demand considerations, traffic congestion, historical pricing data and special charges may be included as well as all anticipated tolls and gratuity charges. As a result, this facility allows matching of the exact type of vehicle and driver 120 to the exact requirement of the passenger 110. If the passenger 110 does not mind sharing a ride, the system 100 can combine several requests based on the destination, pickup and time of the reservation to lower the cost to each of the sharing passengers 110. The server stores existing reservations, and may be enabled to anticipate car availability at certain points in the driver's travels. A such, the system may be enabled to match cars with potential customers who are located near the anticipated destination of the vehicle. The matching may be performed based on estimated travel time of the car that is en route, which in turn may be based upon historical traffic data, speed-limits, road construction or closure information, distance information, calculated travel speed (via GPS, a speedometer interface, or other means), weather conditions and/or other means.

The system may also allow the resale of a reservation to another driver or passenger at a profit or loss because of change in reservation, cancellation or high demand. Also, the system may compare car companies (taxis, livery cars, rental cars, trucks, including the cost of drivers where applicable) based on charging methods. That is, an estimated route distance and travel time of the trip requested by the customer may be calculated. Then, the cost of the trip for cars charging based on distance traveled can be compared with cars charging for travel time. Then, a recommended choice based on the least expensive option may be recommended to the customer.

As a result, customers 110 and drivers 120 can use a central system 130 to conduct all of their transactions in an automated dispatch. In one embodiment, payment is handled by the controller 130 of the system 100 so drivers 120 don't have to carry cash or expensive credit card authorization equipment with them. By centralizing car availability and scheduling from many car, taxi and rental companies a much higher availability, utilization and matching of supply and demand is possible. This results in higher revenues for the car companies while providing lower fares to the passengers 110. Drivers simply select their jobs and then check in electronically to the system each day to confirm their acceptance of the daily trips and go ahead to drive their cars.

Furthermore, the data of the central controller may be linked to the airline, train, ship, hotel, tourist reservation systems and other reservation networks by using dynamic Extensible Markup Language (XML) links. As a result, a complete online trip planning identification scheduling and payment workflow can be enabled. By tracking the location of the scheduled vehicles, the system 100 can ensure that a specific driver 120A is on their way to pick up a specific passenger 110A, and if the driver is not available or has, for example, a problem with their car, the controller 130 immediately reassigns another pending driver 120 with an assignment to perform the job and reconciles the payment data as well as the notification of passenger 110.

According to another embodiment of the present invention, the taxi-reservation system 100 assists drivers 120 with the generation of additional income when they travel one-way over a long distance. As is known, many long distance trips for car service, messenger service as well as cargo transit, are reserved only one way. However, by providing geographic information, as well as other pertinent return travel parameters to the taxi-reservation system 100, a driver 120 can indicate their availability and pick up a ride that otherwise would not be available to them. Once a driver 120 makes their availability known, the controller 130 searches its job queue to determine if there are any possible passengers 110 that desire to make the return trip. If there is any available passenger 110, the controller communicates this information to the driver 120 and a paid ride is scheduled for the driver's return trip. The driver 120 may preset information in the transportation reservation system. The preset information may comprise preferred routes, pick-up and destination locations, preferred fares, preferred times of day, preferred days of the week, etc. The driver 120 may perform a query of the databases of the transportation reservation system via any available means. In various embodiments, the driver may use a touch tone telephone, voice commands, e-mail, an internet connection, or other means. Reservation requests from customers requiring trips that have undesirable characteristics to the driver 120, according to the driver's preset information, will be screened out. This will reduce the number of “hits” a driver 120 receives when performing a query, thereby simplifying the choices that a driver 120 must make. For example, if a driver is taking a customer on a one-way trip to Hartford, Conn. from New York City, he may submit a query for only return trips from Hartford to New York City. As mentioned above, an estimated time of arrival may be determined automatically based on various factors, and thus, a match may be made with a customer desiring to return to New York City at a specific time. Alternatively, if all that can be found is two “half-way trips,” such as a customer desiring to travel from Hartford to Greenwich, Conn., and another customer desiring to travel from Greenwich to New York City, this combination may be used to most efficiently use the driver's time and fuel and minimize wear on the vehicle.

According to another embodiment, a passenger 110 may be provided with an option to bid a fare, which the driver 120 may or may not accept. Generally, however, the driver 120 would likely accept any reasonable fare for such a return trip, since the other option would entail driving back an empty vehicle. Alternatively, drivers, companies, or dispatchers may bid for customers. For example, at peak times of demand, drivers could command higher prices, and thus have customers bidding for them, during low points of demand, drivers may bid for customers. In either case, the driver would most likely be seeking the highest fare possible, while the customer would most-likely be seeking the lowest fare possible. Naturally, if there are other factors that are included, such as sharing, scheduling or route compromises, vehicle quality or condition compromises, or other factors, either the driver or the passenger may decide to seek something other than the highest fare, or lowest fare, respectively.

According to another embodiment, collected historical GPS data can be translated to traffic patterns and made available to any car that has a built-in navigation system or radio and other networks who need access to real time or historical traffic information. Because most traffic patterns are repeated in a weekly or monthly patterns, a car or truck driver may inquire about the traffic conditions between him and a desired destination and send it to controller 130. Controller 130 has a central database which constantly collects data using the GPS technology regarding locations of thousands of cars equipped with devices 125 and other devices which provide location information, by mapping such data to other cars that are in a similar path to the destination as that selected by the driver real time report customized to that specific query can be generated which indicates the best routs to tale to avoid traffic jams or delays. This data is collected over various periods and made available to drivers and other users to assist with charting of a proper and efficient route.

By correlating the speed of advancement and change in GPS data for each car, the system 100 knows which routes are congested and which ones are not, and can instruct the driver to take the vehicle through the least congested path. By constantly updating such information and correlating it to the progress a car is making during a travel, the system 100 can constantly select and rearrange the travel path. Using such data an accurate projections of travel times can be provided to passengers way ahead of their trips so they can make correct flight and hotel reservations, by linking such services to the Sabre and other online reservation systems an integrated one stop reservation and booking can be made with a high degree of accuracy.

Access to such a reservation system 100 can be initiated using other reservation networks, a web browser, wireless devices or telephones, in which case the calls are placed to a central IVR system. The system 100 may have access to external databases containing reservation and availability information as well as possible XML links to outside networks to provide other relevant information such as flight times weather or scheduled arrival and departure of transportation system 100. The interaction with such system 100 can be done by using voice recognition touch tone web interface or wireless devices.

The controller 130 collects and records information related to the users who access the system, including their e-mail addresses, caller identification and wireless device identification, as well as rating and satisfaction information so that it can be shared anonymously with other users of the system 100. Such information is added to the actual performance of drivers 120 which include on time arrival and other relevant parameters.

By providing transportation companies with software that they can use to manage their reservation and scheduling, the central server 130 has access in real-time to the status of both independent car drivers 120 as well as the inventory and availability of car service companies. By calculating supply and demand trends, car companies can vary the price they charge in real-time as well as extend special pricing for good customers 110. The selection can be done automatically by placing limit orders with the system 100 or by individually approving each trip and its price using a hand-held device. The system can also accommodate bulk reservations for hundreds of cars or for private drivers for long periods of time.

As a result of this setup, the job of the dispatchers is changed to deal with exceptions and the maximization of revenues for its taxi fleet, because all the reservation flow is done automatically by the system.

According to one embodiment, the selection and matching process involves accessing a reservation system by a prospective passenger using a computer or wireless device or third party linked software and identifying oneself as an existing or new user. Next, the user selects the geography and time of his or her arrival, and indicates his or her flexibility with timing of pickup and arrival (which dramatically affects price and ability to match a request). The user selects the destination and duration of trip and the number of stops allowed if any. The user may also indicate whether they would prefer to share a ride, which would reduce the cost of the ride. The user may also be able to indicate whether they would be willing to travel a distance to a predetermined pickup location, which would enable more options, and may decrease the cost of the ride. The user may further select a particular driver, or the language a driver speaks, the car type, any special requirements and/or the like. Finally, the user selects a preferred payment method.

This information is transmitted to a central server, where the server then validates the entered data for coverage, accuracy, logic correctness and completeness and/or the like. The server accesses its internal database of available cars and drivers and sorts for matches to the search criteria provided by the customer/user. The matched information is returned in real time to the customer for validation. If acceptable by the customer, the customer confirms the reservation and the system charges the customer. However, a driver, company or dispatcher may choose not to take a passenger based on the (bid) fee, distance to be traveled, desired route, or other parameters. In such a situation, other drivers would be seeked out via the system, and contacted in a like manner.

Such process may also be incorporated as part of other reservation systems to allow, for example, an airline passenger to make his booking and transportation reservation on the airline's web site without having to separately go somewhere else to make his hotel or car reservations.

The system then matches such request and notifies all involved parties (cab driver and the customer) and blocks the time slot from being booked by any other dispatcher or third parties. In one embodiment, the system may also track an airline (where, for example, the user is being picked up from an airport) by accessing the flight database or sending confirmation SMS or e-mail messages to the customer and drivers to reschedule the meeting time or place. The system tracks the car and driver (i.e., cab) via GPS technology or triangulation of a wireless device to confirm that the vehicle is on its way to the meeting point. The system provides notification regarding the final car and driver details via SMS, email or phone call and arranges for a meeting place based on internally generated data or information provided by one of the parties. According to one embodiment, the system connects the two parties if they cannot find each other.

Upon completion of the transaction, the system collects customer satisfaction information using SMS, e-mail or IVR and updates its data records. Payment may be made ahead of time or transferred by the system to the driver or the cab company upon completion of the ride and the identification of the rider by providing his credit card or other id. All related transaction information is transferred to the involved parties which may include direct insertion of expense data to expense reports for corporate users.

According to one embodiment, the system dynamically re-ranks and synchronizes data from each trip regarding the trip time, satisfaction information and pricing information available to other users who try to do reservations.

It should be noted that although the system has been described with respect to the process for arranging automated pickup and transportation of passengers, it can easily be extended to the delivery of goods and the consolidation of available space and utilization of freight in the trucking industry.

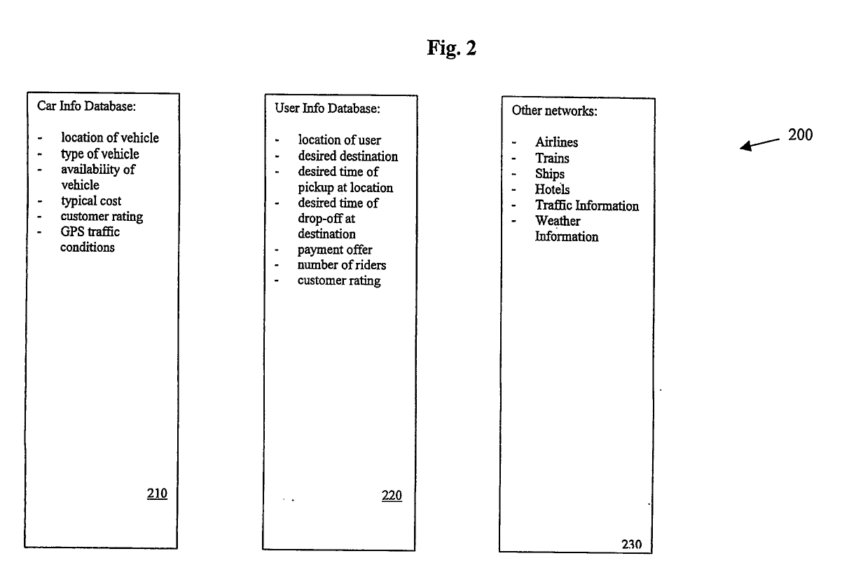

FIG. 2 illustrates an exemplary embodiment of the database 200 for the central controller 130. The database may comprise a car information database 210 and a user/customer information database 220, and a database comprising information from other networks 230. The car information database 210 may store information on the location of vehicle, type of vehicle, availability of vehicle, typical cost of a travel, customer rating, and/or the like. The user/customer information database 220 may store information on the location of a user, desired destinations, desired times of pickup at locations, desired time of drop-off at destination, payment offers, number of riders, customer ratings, and/or the like. The other network database 230 may store information on airline availability, arrival and departure times, approaching weather (snow, rain, storms, etc), train or ship arrival and departure times, hotel room availability information, and traffic information. All of this information would be updated frequently since most of this information is constantly changing. The weather information may be used, for example, to predict the chance of an airline, ship or train delay, the probability of traffic due to weather conditions, and may be used to suggest an alternate route. For example, should there be an approaching winter storm where one would otherwise choose an inland route, but have an option to take an alternate and acceptable route, near to the coast (such that the temperatures might be warmer), and weather conditions more tolerable, a recommendation may be made by the system based on weather information, to take the alternate coastal route. A contrasting example where the opposite may be done would be a situation where there is an approaching hurricane or the like. In such a case it would most likely be best to travel farther inland, than near to the coast.

It is to be understood that the invention is not limited to the locality where the server resides. In an embodiment of the present invention, the car information database may contain data related to several cities. Accordingly, the system is operative to provide transportation service in remote locations.

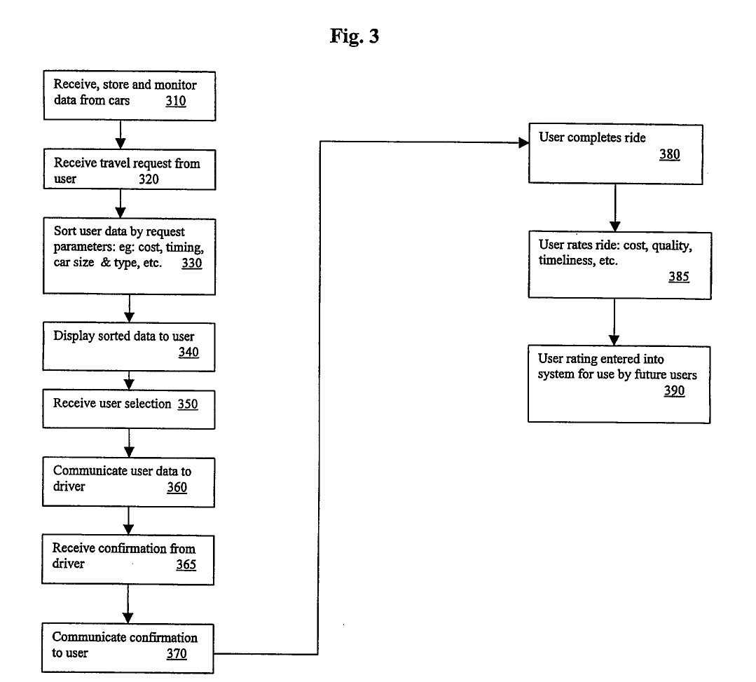

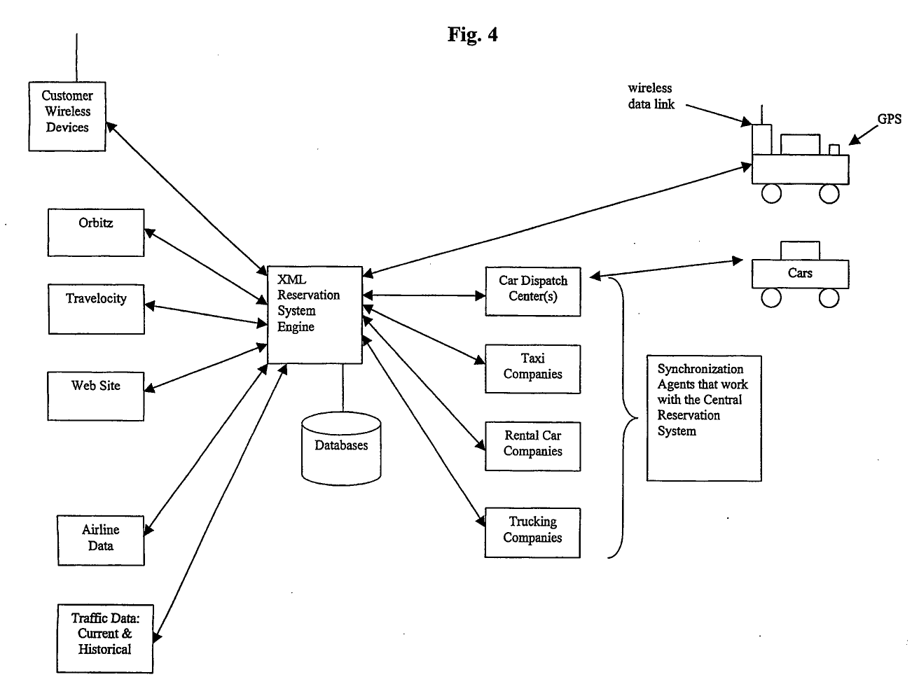

FIG. 3 illustrates an exemplary flow in the central controller 130. At step 310, the central controller 130 receives, stores data from cars. Once a car's information has been recorded in the central controller 130, it continually monitors the car. At step 320, the central controller 130 receives a travel request from a customer.

At step 330, the central controller 130 sorts user data by request the necessary parameters, such as cost, timing, car size and type for the car sought, and/or the lice. At step 340, the central controller 130 display the sorted data to the user. At step 350, the central controller 130 receives the user selection, which is based on the sorted data that was displayed to the user/customer.

At step 360, the central controller 130 communicates user data to the driver. At step 365, the central controller 130 receives confirmation from the cab driver regarding the cab ride that is to be offered. At step 370, the central controller 130 communicates the confirmation information to the customer.

At step 380, the customer completes their cab ride.

At step 385, the customer rates the ride quality by providing information regarding cost, quality, timeliness and/or the like. At step 390, the user rating is entered into the system for use by all future customers.

In summary, the present invention is directed to a method, system and apparatus for providing travel reservations. The travel reservation system receives travel information from a taxi customer, and validates travel information received. Next, the system accesses its central storage to search for available transportation in accordance with the received travel information and transmits availability information regarding available transportation to the taxi customer. The customer transmits confirmation regarding the available transportation, and the system transmits reservation information to a taxi driver in conformance with the confirmation received from the taxi customer.

It is to be understood that the term “taxi” has been used herein and in the following claims in the broadest sense possible. The system mentioned herein is particularly useful for taxis and livery cars, but much of the invention may be applied beneficially to rental cars and rental car companies, as well as truck drivers, and trucking companies. Thus, when the term “taxi” is used, it is meant to incorporate all of these possibilities. For example, a trailer truck driver may be dispatched via the system, and sent to an airport, seaport or rail yard to pick up a container which is to be delivered to a predetermined location. Also, for example, a customer may be flying into an airport and may desire to rent a car. The car may be scheduled to be there via the system. Once the customer is in the car, other features of the system, such as weather alerts, travel route and traffic data, and other features may be used. As can be seen, there are many possible combinations of uses of the features of this system.

Although the invention has been described in detail in the foregoing embodiments, it is to be understood that the descriptions have been provided for purposes of illustration only and that other variations both in form and detail can be made thereupon by those skilled in the art without departing from the spirit and scope of the invention, which is defined solely by the appended claims.

1. A method of receiving assistance with transportation reservations, comprising:
a. accessing a transportation reservation system via an Internet-enabled device, said transportation reservation system being in communication with a plurality of independent travel service providers;
b. transmitting a travel service request to said transportation reservation system;
c. receiving transportation service information from said transportation reservation system in response to said travel service request;
d. transmitting a travel request confirmation to said transportation reservation system; and
e. receiving transportation service in accordance with the confirmation.

2. The method of claim 1, further comprising transmitting payment information to said transportation reservation system.

3. The method of claim 2, further comprising transmitting identification information to said transportation reservation system, wherein said identification information may identify a user as a repeat customer or a first-time customer.

4. The method of claim 3, wherein said travel service request comprises at least one of: location information regarding desired transportation, time of desired transportation, flexibility regarding the time of desired transportation, number of stops between trip origin and trip destination, preference regarding sharing of ride and payment method.

5. The method of claim 4, wherein said travel service request further comprises information regarding taxi driver preference.

6. The method of claim 5, wherein said information regarding taxi driver preference includes at least one of taxi driver's native language, a taxi driver's proficiency in English, type of taxi cab desired and any desired special features.

7. A method of providing travel reservations, comprising:
a. receiving travel information from a taxi customer;
b. validating travel information received from said taxi customer;
c. accessing a central storage device to search for available transportation among a plurality of independent travel service providers in accordance with the received travel information;
d. transmitting availability information regarding available transportation to said taxi customer;
e. receiving confirmation from said taxi customer regarding said available transportation; and
f. transmitting reservation information to a first taxi driver in conformance with the confirmation received from said taxi customer.

8. The method of claim 7, further comprising tracking said first taxi driver to ensure said first taxi driver meets said taxi customer at pre-approved arrival time.

9. The method of claim 8, further comprising calculating the travel time from origination point to destination point of the travel.

10. The method of claim 9, wherein said travel time is calculated based on the distance between the origination point and the destination point and legally allowed speed for the travel.

11. The method of claim 9, wherein a plurality of taxis are provided with devices having Global Positioning System (GPS) facilities, such that said devices transmit traffic information to a central server and allow real time navigation.

12. The method of claim 11, wherein the traffic information includes traffic conditions along a route being taken by one of said plurality of taxis.

13-15. (canceled)

16. The method of claim 8, further comprising charging said taxi customer for the travel.

17. The method of claim 16, further comprising tracking said taxi driver upon receiving confirmation from said taxi customer to confirm that said taxi driver is on route to meet said taxi customer at the scheduled time.

18. The method of claim 17, further comprising receiving customer feedback regarding said travel with said first taxi driver and updating its feedback data.

19. The method of claim 18, further comprising transferring payment to said first taxi driver for the travel.

20-21. (canceled)

22. A method of providing transportation services by a reservation service provider, comprising:
a. receiving notification from a plurality of independent taxi drivers regarding availability for providing transportation;
b. receiving a reservation request from a taxi customer;
c. transmitting said reservation request to a first taxi driver;
d. receiving confirmation from said first taxi driver regarding providing taxi services to said taxi customer in conformance with said reservation request; and
e. transmitting said confirmation from said first taxi driver to said taxi customer.

23. The method of claim 22, further comprising receiving user feedback regarding said taxi services from said taxi customer after said taxi customer has utilized said taxi services.

24. The method of claim 23, wherein said feedback is incorporated into a rating system for use by future taxi customers, wherein said rating system provides rating on a plurality of taxi drivers capable of providing transportation services.

25. The method of claim 24, wherein said plurality of taxi drivers comprises said first taxi driver.

26-94. (canceled)
